(19) United States
(12) Patent Application Publication
(10) Pub. No.: US 2018/0229227 A1
(43) Pub. Date: Aug. 16, 2018

(54) CATALYTIC SYSTEM FOR THE PRODUCTION CARBON MONOXIDE FROM CARBON DIOXIDE INCLUDING IRIDIUM (IR) PHOTOSENSITIZER AND TIO2/RE(I) COMPLEX CATALYST

(71) Applicant: KOREA UNIVERSITY RESEARCH AND BUSINESS FOUNDATION, SEJONG CAMPUS, Sejong-si (KR)

(72) Inventors: Ho-Jin SON, Gyeonggi-do (KR); Sang Ook KANG, Sejong-si (KR); Ha-yeon CHEONG, Jeollabuk-do (KR)

(21) Appl. No.: 15/730,042

(22) Filed: Oct. 11, 2017

(30) Foreign Application Priority Data
Feb. 15, 2017 (KR) 10-2017-0020289

(51) Int. Cl. B01J 31/32; B01J 35/00; B01D 53/86; C01B 32/40; C07F 15/00

(52) U.S. Cl. CPC B01J 31/32; B01J 35/0006; B01D 53/8671; B01D 2255/207; C07F 15/0033; B01D 2257/504; C01B 32/40

(57) ABSTRACT

Disclosed is a catalytic system for the reduction of carbon dioxide to carbon monoxide. The catalytic system includes an iridium (Ir) photosensitizer and a TiO₂/Re(I) complex catalyst. No additional process is required to anchor the molecule-based dye compound on TiO₂ in the synthesis of the catalytic system. This enables the synthesis of the catalytic system in a relatively easy manner for groups of photosensitizer candidates. In addition, the catalytic system can be utilized as a platform for more easily evaluating the abilities of photosensitizers. Furthermore, the catalytic system can find application in various fields due to its ability to selectively produce carbon monoxide gas with high efficiency.

### CROSS REFERENCES TO RELATED APPLICATIONS

The present application claims the benefit and priority to Korean Patent Application No. 10-2017-0020289, filed in the Korean Patent Office on Feb. 15, 2017. The entire disclosure of the application is incorporated herein by reference.

### FIELD

The present invention relates to a catalytic system including an iridium (Ir) photosensitizer and a TiO₂/Re(I) complex (hereinafter referred to as “ReC”) catalyst, and more specifically to a catalytic system for the reduction of carbon dioxide to carbon monoxide including an iridium (Ir) photosensitizer and a TiO₂/Re(I) complex catalyst.

### BACKGROUND

Carbon dioxide reduction is a way to utilize carbon dioxide, a major contributor of global warming, as a carbon resource and provides a fundamental solution to the problem of greenhouse gas emissions. Carbon dioxide reduction is a process for converting carbon dioxide, a root cause of environmental problems, to valuable energy materials. Efficient catalytic systems for visible-light-induced CO₂ reductions have been developed in association with the greenhouse effect due to the rapid increase of CO₂ concentration in the atmosphere by combustion of fossil fuels.

Building up such photocatalytic systems for CO₂ reductions requires optimum combination of a visible-light-absorbing antenna and a CO₂-reduction catalyst that can achieve an efficient visible-light-driven flow of electrons from an electron donor to the catalyst followed by multi-electron reductions of CO₂. Among various catalysts used in visible-light reductions of CO₂, transition-metal complexes have been receiving much attention associated with their potentialities in achieving high catalytic efficiencies and high chemical selectivity.

In particular, Re(I) complexes with a general formula of Re(L)(CO)₃Yⁿ⁺ (L=2,2′-bipyridine or a related ligand, Y=auxiliary ligand, and n=0 or 1) are attractive because of the remarkable capability in performing the efficient and selective reduction of CO₂ to CO, being applied to versatile systems involving homogeneous-solution photosensitization and heterogeneous dye sensitization of the CO₂ reduction under visible-light irradiation.

Recently, the present inventors reported visible-light driven CO₂ reduction with highly improved durability (high turnover number) using a hybrid system, which is constructed by the covalent anchoring of both a visible-light absorbing organic dye (PS) and a Re(I) complex catalyst (ReC) on TiO₂ particles (ternary system in FIG. 2); this system is abbreviated as Dye/TiO₂/ReC. The photocatalytic CO₂ reduction by Dye/TiO₂/ReC proceeds by (1) fast electron injection from the excited-singlet dye into TiO₂, (2) transport of the injected electrons to the ReC site, and (3) the selective two-electron reduction of CO₂ to CO on ReC. An important aspect of this system is that TiO₂ can work as both an electron reservoir and an electron transporter so that ReC fixed on TiO₂ is susceptible of on-demand two-electron supply from TiO₂ followed by complex reaction processes to complete the selective reduction of CO₂ to CO on the catalyst centre. This is a major advantage of the hybrid system in achieving long-term catalytic cycles. However, the apparent quantum yield for the CO₂ reduction is relatively low, mainly due to a low light-harvesting efficiency arising from extensive light scattering by dispersions of the hybrid particles in solution. It can be presumed that incident light should be considerably scattered before reaching to the dye grafted on limited area of the TiO₂ surface. A possible way for avoiding considerable losses of light harvesting would be provided by the use of another system comprising an appropriate photosensitizer (PS) free from TiO₂/ReC (binary system in FIG. 2), because PS present in solution should be more accessible to incident light than the PS fixed on the TiO₂ surface. This system is called a binary hybrid system in order to discriminate it from Dye/TiO₂/ReC which is now called a “ternary” hybrid catalyst. In the binary hybrid system, the excited state dye should mediate electron transfer from an electron donor to TiO₂/ReC in solution. However, the organic dye used in the ternary hybrid catalyst cannot work as an effective PS in homogeneous solution, because the excited state lifetime is too short (≤1 ns) to undergo collisional electron transfer with either TiO₂ or ED.

After having investigated some possible candidates for PS, the present inventors found that cationic iridium(III) complexes [Ir(btp)₂(bpy-X₂)]⁺ (X=OMe, ^{t}Bu, Me, H) effectively work as photosensitizer for the CO₂ reduction using the TiO₂/ReC binary hybrid catalyst. The Ir^{III} complexes have the absorption maximum at ˜430 nm, very close to that of the organic dye used in the ternary catalyst, allowing reasonable comparisons of the photocatalytic behavior between a system of the present invention and Dye/TiO₂/ReC. Herein, the photocatalytic CO₂-reduction behavior of a system of the present invention comprising an I^{III}-complex-based antenna and a TiO₂/ReC binary catalyst is discussed, and the photosensitization capabilities of the I^{III} complexes are compared with that of Ru(bpy)₃²⁺, a widely used photosensitizer, as well as with the photocatalytic behavior of the Dye/TiO₂/ReC ternary system. The present invention has been accomplished based on the finding that the presence of the photosensitizer in homogeneous solution and the use of the heterogenous mixed catalyst enable the reduction of carbon dioxide to carbon monoxide with high efficiency.

### SUMMARY

It is an object of the present invention to provide a catalytic system for the production of carbon monoxide from carbon dioxide including an iridium (Ir) photosensitizer and a TiO₂/Re(I) complex catalyst.

An aspect of the present invention provides a catalytic system including an iridium (Ir) photosensitizer and a TiO₂/Re(I) complex catalyst.

According to the present invention, no additional process is required to anchor the molecule-based dye compound on TiO₂ in the synthesis of the catalytic system. This enables the synthesis of the catalytic system in a relatively easy manner for groups of photosensitizer candidates. In addition, the catalytic system of the present invention can be utilized as a platform for more easily evaluating the abilities of photosensitizers. Furthermore, the catalytic system of the present invention can find application in various fields due to its ability to selectively produce carbon monoxide gas with high efficiency.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows groups of photosensitizers, photocatalysts, and sacrificial reagents that can be used in alternative embodiments of the present invention;

FIG. 2 illustrates reaction systems related to the application of Re(I) complexes to the visible-light-induced reduction of CO₂ to CO, (a) homogeneous-solution photosensitization (homogeneous system) that is generally initiated by electron transfer from an electron donor to a photosensitizer in the excited state followed by electron donation from the one-electron reduced species of PS to ReC, (b) a dye sensitization system (ternary system) constructed by anchoring both PS and ReC on semiconductor particles, in which electrons are injected into the semiconductor from excited-state PS and then transported to ReC, and (c) a mixed system (binary system) of the present invention comprising free PS and ReC-anchored semiconductor particles;

FIG. 3 shows a photosensitization system of the present invention and structures of molecules used in the photosensitization system;

FIG. 4 shows structures of (a) Ir-H⁺ and (b) Ir-OMe⁺ obtained by X-ray crystallographic analysis. Displacement ellipsoids are drawn at the 30% probability level and H atoms have been omitted for clarity;

FIG. 5 shows (a) absorption spectra of Ir—X⁺ in acetonitrile and (b) emission spectra of Ir—X⁺ (10 μM) taken by excitation at 300 nm in acetonitrile at room temperature. Insets in (a) and (b) show an expanded view for the low-energy spectral region and phosphorescence decay profiles of Ir—X⁺ in acetonitrile at room temperature, respectively;

FIG. 6 shows absorption spectra of (a) Ir—H⁺, (b) Ir-OMe⁺, and (c) Ir—CN⁺ in DMF during irradiation for 24 hours;

FIG. 7 shows cyclic voltammograms of Ir—X⁺ (1 mM) in the oxidation (a) and reduction (b) sides for 0.1 M acetonitrile solution of tetrabutylammonium perchlorate (TBAP) at a scan rate at 50 mVs⁻¹;

FIG. 8 shows plots of TN_{CO} versus irradiation time for 4 h (a) and 10 h irradiation (b); irradiation at ≥400 nm for dispersions of 10 mg TiO₂/ReC (0.1 μmol) in CO₂-saturated DMF involving 1 mM Ir—X⁺ and 0.1 M BIH and 2.5 vol % H₂O;

FIG. 9 shows plots of TN_{CO} versus irradiation time for an Ir-OMe⁺-TiO₂/ReC binary system (black solid squares), a Ru(bpy)²⁺-TiO₂/ReC binary system (inverted solid triangles), a Dye/TiO₂/ReC ternary system (blue solid triangles), an Ir-OMe⁺-RePE homogeneous system (red solid circles), and a TiO₂/ReC catalyst in the absence of PS (pink open circles) (a), and the TN_{CO} values after 4 h irradiation (b). Irradiation at ≥400 nm for the systems in CO₂-saturated DMF containing 0.1 M BIH and 2.5 vol % H₂O;

FIG. 10 shows plots of CO formation versus time for PS⁺-RePE in CO₂-saturated DMF containing 0.1 M BIH. Irradiation at ≥400 nm;

FIG. 11 shows essential reaction processes (Eqs 1-6) for discussing structure-reactivity relationships in the photosensitized CO₂ reduction based on a binary system of the present invention;

FIG. 12 shows a Stern-Volmer plot for quenching of the phosphorescence of an Ir-OMe⁺ complex by BIH in DMF at a wavelength of 427 nm;

FIG. 13 shows cyclic voltammograms of 1 mM PS measured on a platinum electrode (Φ=3 mm) in DMF containing 0.1 M TBAPF₆ at a scan rate of 50 mVs⁻¹;

FIG. 14 shows relative energy levels (V vs SCE) of the flat-band potential (E_{fb}) of TiO₂, the oxidation potentials of PS^{-·} (Eₚₐ^{red}) and the reduction potential of ReC represented by that of RePE (E(RePE)_{1/2}^{red});

FIG. 15 shows absorption spectra of Ir—H⁺ (a), Ir-Me⁺ (b), Ir-^{t}Bu⁺ (c), and Ir-OMe⁺ (d) in DMF containing 0.25 mM BIH after 0-5 h irradiation. Insets show absorbance values of produced [Ir—X⁺]⁻, indicating photostability of PS⁻; and

FIG. 16 shows changes of absorption spectra following irradiation time for Ir-^{t}Bu⁺ (a) and for Ir-OMe⁺ (b) in DMF containing 0.05 mM Ir—X⁺ and 0.25 M BIH, and plots of absorbance change (I/I₀) vs. irradiation time (c) monitored at the wavelength shown by the vertical broken lines in (a) and (b) for Ir-^{t}Bu⁺ (blue open and close squares) and for Ir-OMe⁺ (red open and close circles). I₀ and I denote the absorbance after 5 min irradiation and longer-time irradiation, respectively.

### DETAILED DESCRIPTION

Unless defined otherwise, all technical and scientific terms used herein have the same meaning as commonly understood by the ordinary skilled in the art expert. In general, the nomenclature used herein is well-known and commonly used in the art.

In an aspect, the present invention is directed to a catalytic system including an iridium (Ir) photosensitizer and a TiO₂/Re(I) complex catalyst.

In the present invention, the valence of the iridium is trivalent.

In the present invention, the iridium photosensitizer may be selected from the group consisting of Ir-OMe⁺, Ir-tBu⁺, Ir-Me⁺, and Ir—H⁺.

The catalytic system of the present invention further includes a sacrificial reagent. The sacrificial reagent may be BIH but is not limited thereto.

The catalytic system of the present invention is a binary system.

The catalytic system of the present invention reduces carbon dioxide (CO₂) to produce carbon monoxide (CO).

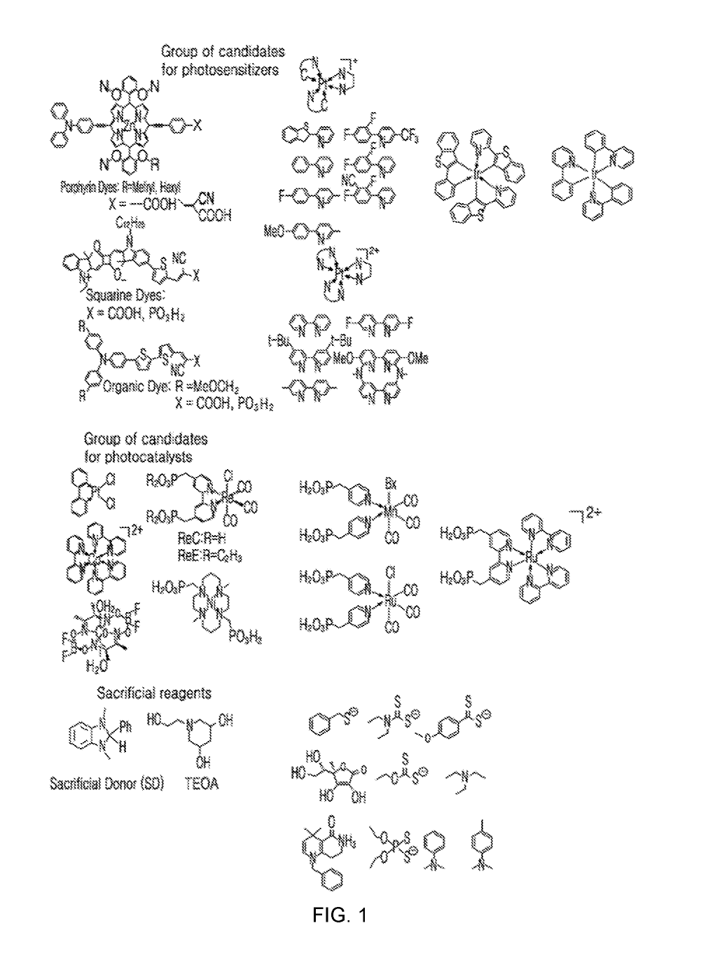

Groups of photosensitizers, photocatalysts, and sacrificial reagents (FIG. 1) other than the iridium (Ir) photosensitizer and the TiO₂/Re(I) complex catalyst used in the binary catalytic system of the present invention may be used in alternative embodiments of the present invention.

The present invention will be explained in more detail with reference to the following examples. It will be evident to those skilled in the art that these examples are merely for illustrative purposes and are not to be construed as limiting the scope of the present invention. Therefore, the true scope of the present invention should be defined by the appended claims and their equivalents.

### EXAMPLE 1

### General Procedure

All the synthetic procedures were performed in a dry dinitrogen atmosphere. All the solvents used were distilled over sodium-benzophenone under nitrogen prior to use. Benzo[b]thiophene-2-boronic acid and 2-bromopyridine were purchased from Sigma-Aldrich and used without further purification. Glassware, syringes, magnetic stirring bars, and needles were dried in a convection oven for over 4 h. Reactions were monitored by thin-layer chromatography (TLC; Merck Co.). The spots developed onto TLC were identified under UV light at 254 or 365 nm. Column chromatography was performed on silica gel 60 G (particle size 5-40 μm; Merck Co.). The synthesized compounds were characterized by ¹H-NMR, ¹³C-NMR, and HR-MS. ¹H- and ¹³C-NMR spectra were recorded using a Varian Mercury 300 spectrometer operating at 300.1 and 75.4 MHz, respectively. The elemental analyses were performed using a Carlo Erba Instruments CHNSO EA 1108 analyzer by the Korean Basic Science Institute. HR-MS analysis was performed on an LC/MS/MSn (n=10) spectrometer (Thermo Fisher Scientific, LCQ Fleet Hyperbolic Ion Trap MS/MSn Spectrometer).

### EXAMPLE 2

### Synthesis of Ir(III) Complexes

Ir(III) complexes (Ir-OMe⁺, Ir-^{t}Bu⁺, Ir-Me⁺, and Ir—H⁺), Re(4,4′-Y₂-2,2′-bipyridine)(CO)₃Cl (ReC (Y═CH₂PO₃H₂), RePE (Y═CH₂PO(OC₂H₅)₂)), and organic sensitizer (dye=(E)-2-cyano-3-(5′-(5″-(p-(diphenylamino)phenyl)thiophen-2″-yl)thiophen-2′-yl)-acrylic acid) were prepared.

2-1: Synthesis of [Ir(btp)₂(bpy-CN)₂]⁺PF₆ (Ir—CN⁺)

A mixture of Ir-dimer complex (0.088 g, 0.068 mmol) and 4,4′-dicyano-2,2′-bipyridine (bpy-CN: 0.029 g, 0.14 mmol) in ethylene glycol (5.9 mL) was heated at 150° C. for 45 h under nitrogen. The reaction mixture was poured into water (40 mL) and washed with diethyl ether (40 mL×2). To the aqueous layer was added ammonium hexafluorophosphate (0.610 g, 3.74 mmol). The organic mixture products were extracted with dichloromethane (40 mL×2) and the solvent was removed by rotary evaporation under vacuum. The solids were collected by filtration, washed with water and vacuum dried. The obtained crude product was purified by column chromatography on silica gel (solvent: methanol/dichloromethane, 1:6 v/v), followed by recrystallization from dichloromethane through n-hexane vapor diffusion to yield complex Ir—CN⁺ as dark-green crystals (0.056 g, 0.058 mmol, 85% yield).

¹H NMR (300 MHz, DMSO-d₆) δ 9.54 (s, 2H), 8.13 (d, J=7.2 Hz, 2H), 8.xx8.0x (m, 4H), 7.95 (m, 4H), 7.77 (d, J=5.7 Hz, 2H), 7.23 (t, J=7.5 Hz, 2H), 7.08 (t, J=6.9 Hz, 2H), 6.88 (t, J=8.0 Hz, 2H), 5.86 (d, J=8.1 Hz, 2H).

¹³C NMR (100.6 MHz, DMSO-d₆) δ 163.17, 155.69, 151.87, 150.89, 145.64, 144.61, 142.10, 140.69, 136.47, 132.10, 128.63, 125.84, 124.49, 124.15, 123.57, 122.67, 122.21, 119.99, 115.65.

ESI-MS calcd. for C₄₄H₃₆F₆IrN₆PS₂, 819.0977 [M-PF₆⁺; found 819 [M-P F₆⁺.

2-2: Confirmation of Synthesized Molecular Structures

Cationic Ir^{III}-complexes denoted as Ir—X⁺PF₆⁻(X=OMe, ^{t}Bu, Me, H, and CN) were synthesized from dimeric Ir₂(btp)₄Cl₂ and 4,4′-X₂-2,2′-bipyridines (X₂-bpy) in moderate yields following a literature method. The preparation of Ru(bpy)₃²⁺(PF₆⁻)₂ used as a comparative photosensitizer was performed according to the published method. The structures of Ir—X⁺PF₆⁻ were confirmed by the spectroscopic and elemental analyses.

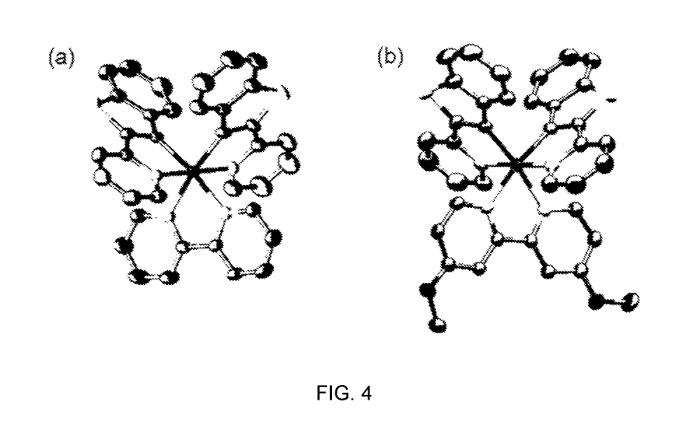

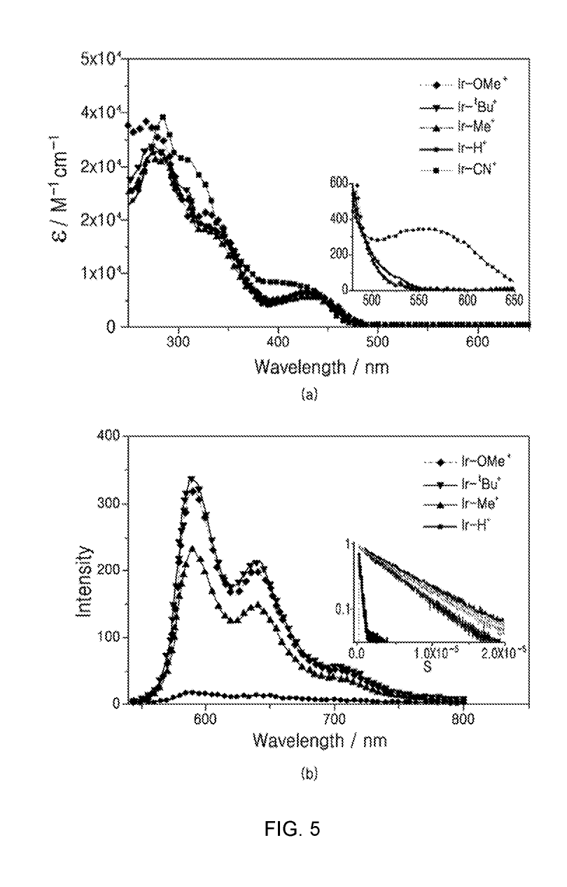

In particular, Ir—H⁺PF₆⁻ and Ir-OMe⁺PF₆⁻ gave fine crystals relevant to X-ray crystallographic analysis, revealing a monoclinic crystal system of the P2_{1/n} space group with reliability factors of R₁=0.0315 and 0.0286, respectively. The (2-pyridyl)benzo[b]thiophen-3-yl ligands are commonly bonded to the iridium(III) center with cis-C,C and trans-N,N dispositions (FIG. 4).

### EXAMPLE 3

### Characterization of the Ir(III) complexes

3-1:Crystal Structure Determination

Fine crystals of Ir—H⁺ and Ir-OMe⁺ obtained from a dichloromethane/n-hexane solution were sealed in glass capillaries under argon, and mounted on a diffractometer. The preliminary examination and data collection were performed using a Bruker SMART CCD detector system single-crystal X-ray diffractometer equipped with a sealed-tube X-ray source (50 kV×30 mA) using graphite monochromated Mo K_{α} radiation (λ=0.71073 Å). The preliminary unit cell constants were determined using a set of 45 narrowframe (0.3° in ω ) scans. The double pass method of scanning was used to exclude noise. The collected frames were integrated using an orientation matrix determined from the narrow-frame scans. The SMART software package was used for data collection, and SAINT was used for frame integration. The final cell constants were determined through global refinement of the xyz centroids of the reflections harvested from the entire dataset. Structure solution and refinement were carried out using the SHELXTL-PLUS software package.

3-2: Cyclic Voltammetry (CV)

CV was performed for an acetonitrile or DMF solution containing each of the electroactive compounds (1 mM) and 0.1 M tetrabutylammonium perchlorate at room temperature under an Ar atmosphere using a BAS 100B electrochemical analyzer equipped with a platinum working electrode, a platinum wire counter electrode, and an Ag/AgNO₃ (0.1 M) reference. All the potentials were calibrated to the ferrocene/ferrocenium (Fc/Fc⁺) redox couple.

3-3: Steady-State and Time-Resolved Spectroscopic Measurements

Absorption spectra were recorded on a Shimadzu (UV-3101PC) scanning spectrophotometer. Emission and excitation spectra were measured by using a Varian fluorescence spectrophotometer (Cary Eclipse). For time-resolved spectroscopy, an Ar-purged acetonitrile solution of Ir—X⁺ was irradiated with 309 nm pulses, which were generated by modulating the third harmonic (355 nm) of a Q-switched Nd:YAG laser (Continuum, Surelite II, pulse width of 4.5 ns) with an H₂-Raman shifter. The emitted phosphorescence was recorded using an ICCD detector (Andor, iStar) equipped with a monochromator (DongWoo Optron, Monora 500i). The temporal profiles were measured using a monochromator equipped with a photomultiplier (Zolix Instruments Co., CR 131) and a digital oscilloscope (Tektronix, TDS-784D). Phosphorescence lifetimes were measured according to a single photon counting method using a streak scope (Hamamatsu Photonics, C10627-03) equipped with a polychromator (Acton Research, SP2300). Ultra-short laser pulses were generated from a Ti:sapphire oscillator (Coherent, Vitesse, FWHM 100 fs) pumped with a diode-pumped solid-state laser (Coherent, Verdi). High-power (1.5 mJ) pulses were generated using a Ti:sapphire regenerative amplifier (Coherent, Libra, 1 kHz). The pulses at 330 nm generated from an optical parametric amplifier (Coherent, TOPAS) were used as the excitation light. The temporal emission profiles were well-fitted to a single-exponential function. The time resolution is ˜20 ps after the deconvolution procedure. The fitting was judged by weighted residuals and the X² values.

3-4: Photophysical Properties of Ir—X⁺

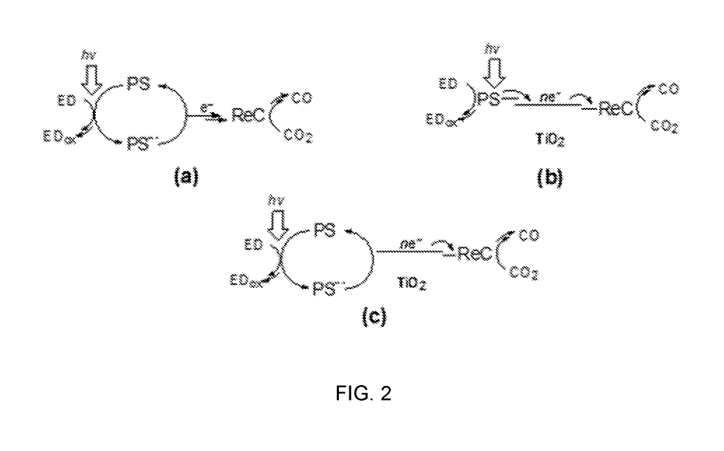

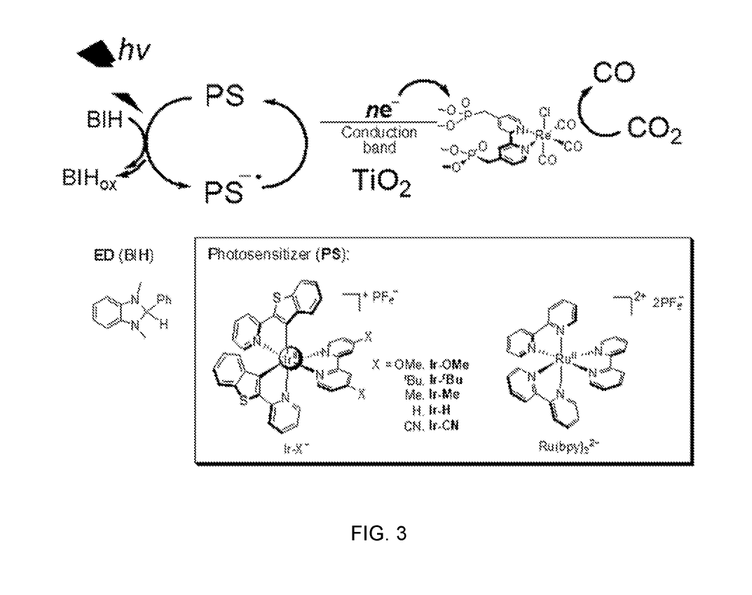

The UV-visible absorption and emission spectra of Ir—X⁺ were measured in acetonitrile. The absorption maxima and molar extinction coefficients are summarized in Table 1. All complexes commonly reveal intense absorptions at ˜250 and ˜350 nm assignable as the Π-Π* transitions of the X₂-bpy and btp ligands, respectively, and a less intense absorption band at ˜430 nm attributable to a transition with a dominant contribution of Ir^{III}-to-btp charge transfer (FIG. 2). In the case of Ir-CN⁺, an extra weak band appears around 560 nm, which is attributable to other transition with a contribution of the (CN)₂-bpy ligand as reported for another Ir—X⁺ complex (X═CF₃).

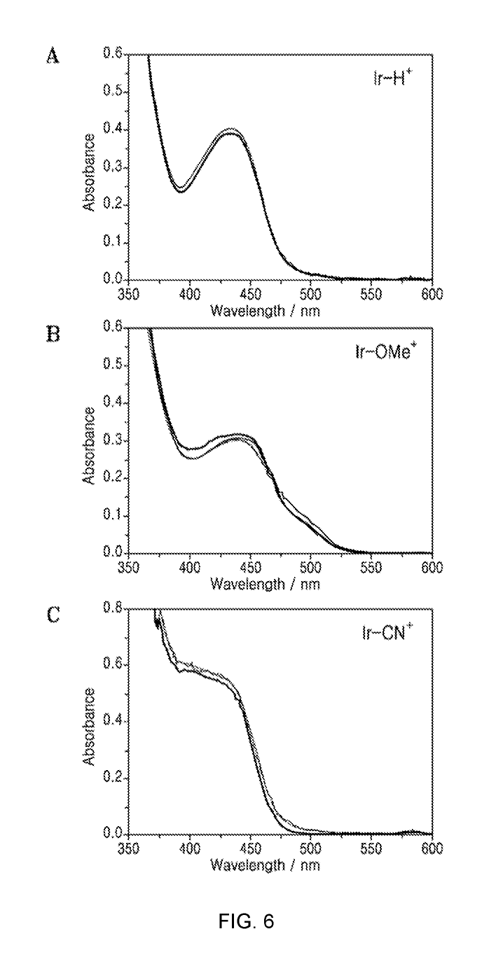

The emission spectra of Ir—X⁺ were measured in degassed acetonitrile at room temperature, and the data are summarized in Table 1. The Ir(III) complexes reveal similar phosphorescence spectra with the maxima at ˜590 and ˜640 nm accompanied by a shoulder at ˜701 nm, while Ir—CN⁺ is virtually nonemissive even at 77 K. Table 1 lists the quantum yields (Φ) and lifetimes (T) of phosphorescence for the four emissive complexes, which uniquely depend on the substituent (X) of the bpy ligand. From the observed values of Φ and T, the rate constants of the radiative and nonradiative pathways (kᵣ and kₙᵣ) were calculated. While the kᵣ values are similar with minor differences, kₙᵣ increases in the order Ir-OMe⁺≈Ir-^{t}Bu⁺≤Ir-Me⁺<<Ir—H⁺, an interesting dependence on the bulkiness and/or electron-donating character of X. Since the emissive complexes reveal almost identical phosphorescence spectra and similar kᵣ values independently of the X₂-bpy ligand, the btp ligand should be dominantly involved in the emissive excited state accompanied by a small or negligible contribution of the X₂-bpy ligand. The phosphorescence of Ir—X⁺ should commonly occur from a state with a dominant or major contribution of the btp-centered triplet (³LC) mixed with a metal-to-ligand charge-transfer (³MLCT) character, as reported for similar heteroleptic and homoleptic Ir^{III} analogues with the btp ligand. On the other hand, the kₙᵣ values significantly vary with X, suggesting that the X₂-bpy ligands significantly contribute to the nonradiative decay process (or processes) from the emissive state. A possible assumption is that vibrational modes in the X₂-bpy ligands would be more or less coupled with the crossing from the emissive state to other nonemissive state(s), e.g. a metal-centred triplet state (³MC). Alternatively, the electron-donating OMe, ^{t}Bu, and Me substituents would more or less enhance the electron density on the Ir(III) centre in the excited state to result in an increase of the barrier for the crossing to the nonradiative state(s). In the case of Ir-CN⁺, the strong electron-withdrawing effect of the two CN substituents should cause a significant reduction of the electron density on the metal centre to result in a barrierless crossing to the putative ³MC state. Alternatively, the lowest-excited singlet state of Ir—CN⁺ different from that of the other complexes would undergo direct intersystem crossing to a nonemissive triplet state. At any rate, if the nonemissive state would be coupled with a chemical change of Ir—X⁺, the Ir(III) complexes are not attractive as PS. Fortunately, it was confirmed that all the complexes are totally stable under long-term irradiation in DMF (FIG. 6), an observation demonstrating that Ir—X⁺ can work as potential photosensitizer for the present CO₂-reduction investigation.

TABLE 1 Photophysical properties of Ir—X⁺

TABLE 1
Photophysical properties of Ir—X⁺

| | ^{[a]}λ_{abs} (nm) (ε (10³ M⁻¹ cm⁻¹)) | ^{[b]}λₑₘ (nm) | ^{[c]}φ | ^{[d]}τ (μs) | ^{[e]}kᵣ (10⁴ s⁻¹) | ^{[f]}kₙᵣ (10⁵ s⁻¹) |
|---|---|---|---|---|---|---|
| Ir—OMe⁺ | 268(38), 328(21), 427(6) | 591, 640, | 0.107 | 5.64 | 1.90 | 1.58 |
| | | 701 | | | | |
| Ir—^{t}Bu⁺ | 272(34), 309(26), 327(19), | 589, 638, | 0.116 | 6.47 | 1.79 | 1.37 |
| | 430(6) | 702 | | | | |
| Ir—Me⁺ | 272(31), 308(24), 326(18), | 590, 638, | 0.064 | 4.39 | 1.46 | 2.13 |
| | 427(6) | 703 | | | | |
| Ir—H⁺ | 277(33), 311(25), 335(18), | 590, 641 | 0.009 | 0.255 | 3.53 | 38.9 |
| | 431(6) | | | | | |
| Ir—CN⁺ | 284(39), 310(31), 327(26), | ^{[g]}— | ^{[g]}— | ^{[g]}— | ^{[g]}— | ^{[g]}— |
| | 401(8), 429(7), 560(0.3) | | | | | |
| Ru(bpy)₃²⁺ | 244(25), 287(84), 451(14) | 621 | 0.095 | 0.855 | 10.6 | 10.2 |

^{[a]}Absorption maxima (molar extinction coefficient).
^{[b]}Phosphorescence maxima.
^{[c]}Phosphorescence quantum yield measured in deaerated acetonitrile.
^{[d]}Phosphorescence lifetime measured in deaerated acetonitrile.
^{[e]}Radiative rate constant.
^{[f]}Nonradiative rate constant.
^{[g]}No luminescence.

3-5: Electrochemical Properties of Ir—X⁺

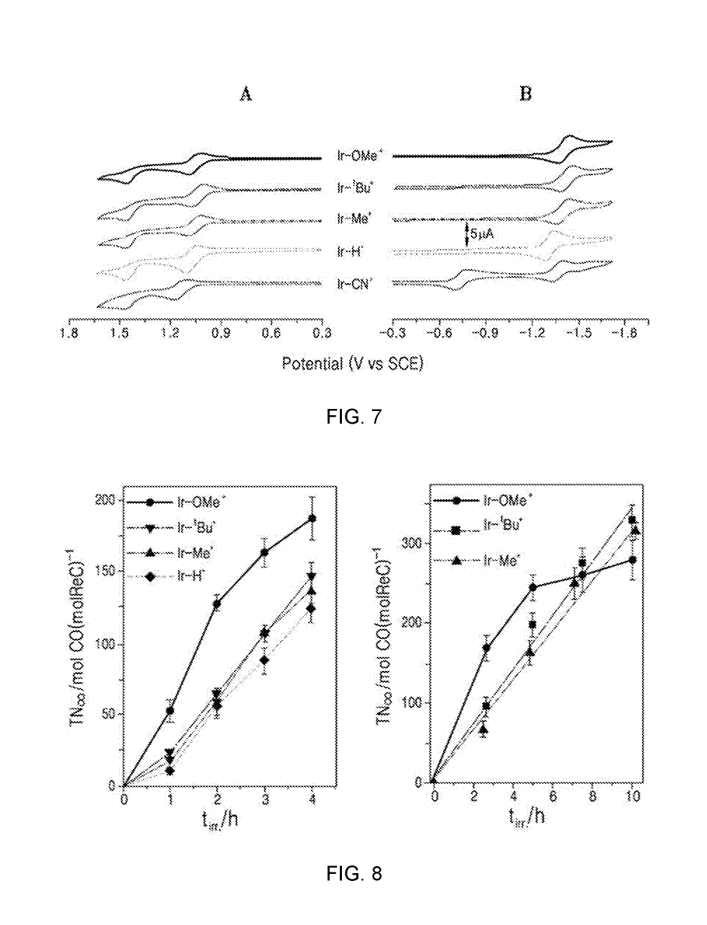

The electrochemical properties of Ir—X⁺ were examined by cyclic voltammetry (CV), the data of which are summarized in Table 2. Typical CV scans of Ir—X⁺ are shown in FIG. 7, revealing pseudo reversal behaviour with distinct anodic and cathodic waves in both the positive and negative sides, from which the half-wave oxidation and reduction potentials, E_{1/2}^{ox} and E₁₂^{red}, were estimated. The E_{1/2}^{ox} values are almost identical within 30 mV differences except for Ir—CN⁺ where the potential is more positive by 70˜100 mV. Since the highest-occupied molecular orbital (HOMO) can be considered to dominantly populate on the Ir(III) center, the energy levels would be not significantly changed by the OMe and alkyl substituents of X₂-bpy. In the case of X═CN, however, the strong electron-withdrawing effect would cause an appreciable decrease of electron density on the metal centre to result in a substantial shift of the HOMO level. With respect to the reduction potential, the E_{1/2}^{red} values in the cases of X=OMe, ^{t}Bu, and Me are again similar within 20 mV differences, but appreciably more negative by ˜100 mV than that of Ir—H⁺. On the other hand, Ir—CN⁺ reveals a substantially more positive shift of E_{1/2}^{red} by 570˜680 mV. This behavior implies that the electron-donating and electron-withdrawing character of the substituent X on the bpy ligand should affect the LUMO level of Ir—X⁺ to slight, but significant, degrees more than the HOMO level. Presumably, the electron introduced into Ir—X⁺ would be more or less developed on the bpy ligand depending on the substituent X, though the LUMO would be mainly populated on the btp ligand.

TABLE 2
Electrochemical data and related energy levels for PSs

| Sample | ^{[a]}E_{1/2}^{ox} [V] | ^{[a]}E_{1/2}^{red} [V] | ^{[b]}E₀₋₀ [eV] | ^{[e]}HOMO [eV] | ^{[e]}LUMO [eV] | ^{[c]}E_{red}* (V) | ^{[d]}Eₒₓ* (V) |
|---|---|---|---|---|---|---|---|
| Ir—OMe⁺ | 1.06 | −1.41 | 2.13 | −5.48 | −3.01 | 0.72 | −1.07 |
| Ir—^{t}Bu⁺ | 1.04 | −1.42 | 2.13 | −5.46 | −3.00 | 0.71 | −1.09 |
| Ir—Me⁺ | 1.05 | −1.40 | 2.13 | −5.47 | −3.02 | 0.73 | −1.08 |
| Ir—H⁺ | 1.07 | −1.31 | 2.13 | −5.49 | −3.11 | 0.82 | −1.06 |
| Ir—CN⁺ | 1.14 | −0.74 | 1.93 | −5.56 | −3.68 | 1.19 | −0.79 |
| Ru(bpy)₃²⁺ | 1.25 | −1.35 | 2.03 | −5.67 | −3.07 | 0.68 | −0.78 |

^{[a]}Eₚₐ = anodic peak potential, E_{pc} = cathodic peak potential, and E_{1/2} = (E_{pc} + Eₚₐ)/2 vs SCE.
^{[b]}E₀₋₀ denotes triplet energy estimated from the phosphorescence data at 77 K.
^{[c]}Excited-state reduction potential estimated using E_{red}* = E_{1/2}^{red} + E₀₋₀.
^{[d]}Excited-state oxidation potential estimated using Eₒₓ* = E_{1/2}^{ox} − E₀₋₀.
^{[e]}HOMO and LUMO levels were determined using the following equations: E_{HOMO} (eV) = −e(E_{1/2}^{ox} + 4.42), E_{LUMO} (eV) = −e(E_{1/2}^{red} + 4.42).

### EXAMPLE 4

### Preparation of TiO₂/ReC Catalyst and Photosensitized CO₂ Reduction

4-1: Preparation of TiO₂/ReC Catalyst

Commercially available TiO₂ particles with specific Brauner-Emmet-Teller (BET) surface areas of ≥250 m²/g were thoroughly washed with distilled water, ultrasonically treated in water, separated by centrifugation, and then dried in an oven under N₂. The TiO₂ particles (0.125 g) were stirred overnight in a 50 mL solution of ReC (fac-[Re(4,4′-Bis(dihydroxyphosphorylmethyl)-2,2′-bipyridine)(CO)₃Cl]) (1 μmol) in MeCN/tert-butanol, and then subjected to centrifugation. The collected solids were washed with the solvent and then dried in an oven under N₂. The successful anchoring of ReC on TiO₂ was confirmed by the IR absorption bands characteristic of the CO ligands at 2025, 1920, and 1910 cm⁻¹.

4-2: Photocatalyzed CO₂ Reduction

Suspensions of TiO₂/ReC particles (0.1 μmol ReC on 10 mg TiO₂) in 3 ml N,N-dimethylformamide (DMF) containing 1 mM PS ( Ir—X⁺ or Ru(bpy)₃²⁺), 0.1 M BIH, and 2.5 vol % H₂O were placed in a pyrex cell (˜1 cm pass length; 6.0 mL total volume), bubbled with CO₂ for 30 min, sealed with a septum, and then irradiated under stirring with visible light at ≥400 nm emitted from a LED lamp (60 W, Cree Inc.). Homogeneous-solution photoreactions were performed for 3 mL DMF solutions of Ir—X⁺ (0.5 mM), RePE (0.5 mM), and BIH (0.1 M). The amounts of CO evolved in the overhead space of the cell were determined by gas chromatography (HP6890A GC equipped with a TCD detector) using a 5 Å molecular sieve column. The liquid phase of the irradiated samples was subjected to HPLC analysis using a Waters 515 pump, a Waters 486 UV detector operated at 210 nm, a Rspak KC-811 Column (Shodex) and 0.05 M H₃PO₄ aqueous solution eluent.

4-3: Confirmation of Photocatalytic CO₂ Reduction

The hybrid catalyst (TiO₂/ReC) was prepared by anchoring Re(4,4′-Y₂-bpy)(CO)₃Cl (Y═CH₂PO₃H₂) on TiO₂ particles. Suspensions of TiO₂/ReC particles in CO₂-saturated DMF containing PS ( Ir—X⁺ or Ru(bpy)₃²⁺, 1 mM), BIH (0.1 M), and 2.5 vol % H₂O were irradiated at ≥400 nm using a LED lamp (60 W, Cree Inc.). When using Ir—X⁺ as a photosensitizer, the photoreactions gave CO as the exclusive CO₂-reduction product accompanied by negligible amounts of H₂ and formic acid, while in the case of Ru(bpy)₃²⁺ two CO₂-reduction products (CO and HCOOH) were produced comparably with small amount of H₂ production. It was confirmed that little CO was formed in the absence of either or both of PS and BIH. FIG. 8 shows plots of TN_{CO} (=molar ratio of CO formed/ReC used) vs irradiation time. After 4 h irradiation, TN_{CO} reaches ˜180 with Ir-OMe⁺ and 120-140 with the others except for Ir—CN⁺; Ir—CN⁺ is inactive as PS. It should be, however, noted that Ir-OMe⁺ reveals the highest photosensitization efficiency at an initial stage of the reaction but shows a levelling-off tendency after 2 h irradiation, probably due to chemical changes of Ir-OMe⁺ occurring during the photosensitization. On the other hand, the TN_{CO} plots for Ir-^{t}Bu⁺ and Ir-Me⁺ are linear up to 8 h to give ˜300 of TN_{CO} (FIG. 8), demonstrating that both Ir-^{t}Bu⁺ and Ir-Me⁺ are slightly less efficient but much more stable as PS than Ir-OMe⁺.

4-4: Comparison with the Other Photosensitization Systems

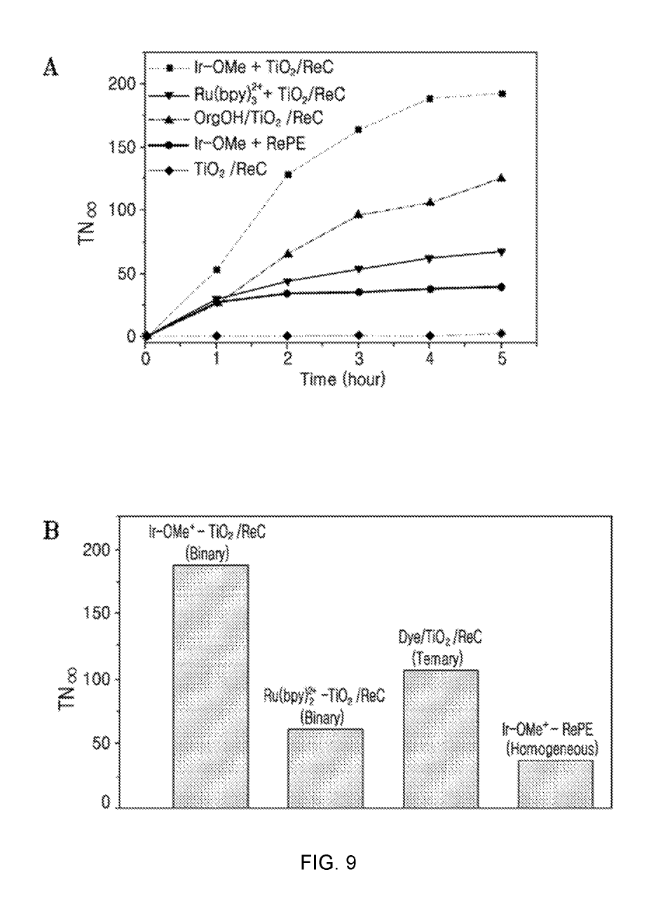

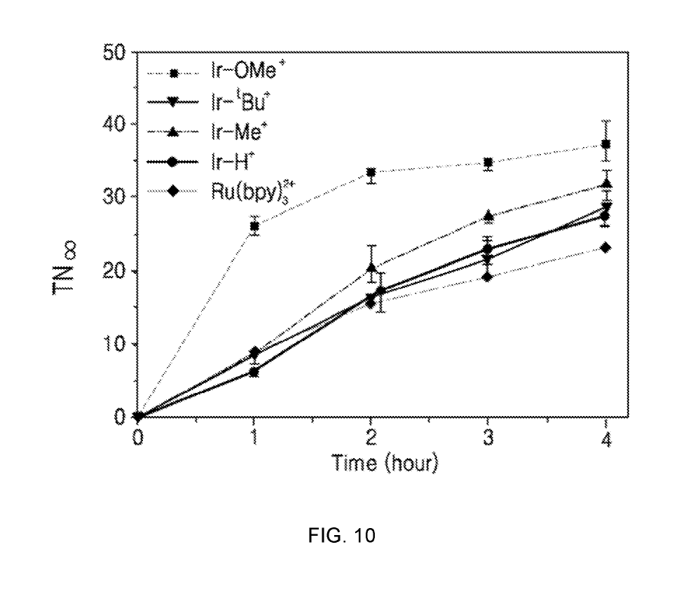

For comparison, the other photosensitization systems ((a) and (b) of FIG. 2) were applied to the photocatalytic reduction of CO₂ under similar conditions, i.e. (1) a binary hybrid system using Ru(bpy)₃²⁺ as PS in place of Ir—X⁺ (abbreviated as Ru(bpy)₃²⁺-TiO₂/ReC), (2) a homogeneous system using Ir-OMe⁺ as PS and RePE as CO₂ reduction catalyst (Ir-OMe⁺-RePE), and (3) the Dye/TiO₂/ReC ternary hybrid system. FIG. 9 shows plots of TN_{CO} vs irradiation time for these systems compared with that for the binary hybrid system using Ir-OMe⁺ as PS (Ir-OMe⁺-TiO₂/ReC). In the case of Ru(bpy)₃²⁺-TiO₂/ReC, levelling-off behavior of TN_{CO} starts even at an early stage to give a low TN_{CO} (˜50) after 4 h irradiation, considerably lower than that for Ir-OMe⁺-TiO₂/ReC, demonstrating that Ir-OMe⁺ does work as a considerably more efficient PS than Ru(bpy)₃²⁺, a well-known transition-metal-complex photosensitizer. This is again true for the other Ir—X⁺ sensitizers (X=^{t}Bu, Me, and H). Furthermore, the Ir-OMe⁺-RePE homogeneous system gave still worse results that the levelling-off tendency in the CO formation occurs at an early stage of the photoreaction to give a very low TN_{CO} (˜30) after 4 h irradiation (FIG. 10). The hybridization of the ReC catalyst with TiO₂ enables the catalyst to persistently work, providing a potential strategy for designing efficient catalytic systems based on molecular catalysts. It is of interest to note that TN_{CO} of the Dye/TiO₂/ReC ternary system is ˜1.8 fold lower than that of the Ir-OMe⁺-TiO₂/ReC binary system and slightly lower than those of the binary system using the other Ir—X⁺ sensitizers (X=^{t}Bu, Me, and H), perhaps due to light scattering effects in the ternary system.

### EXAMPLE 5

### Structure-Reactivity Relationships in the Photosensitized CO₂ Reduction Based on the Binary System

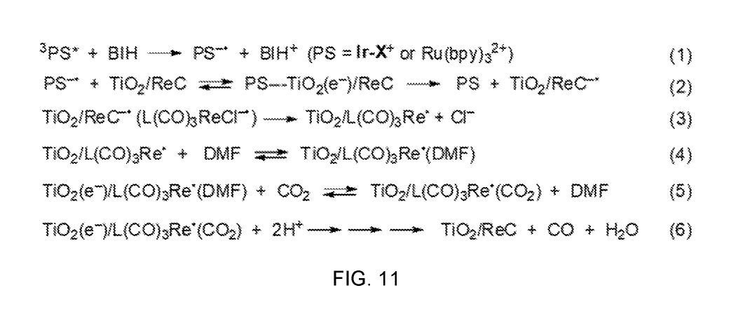

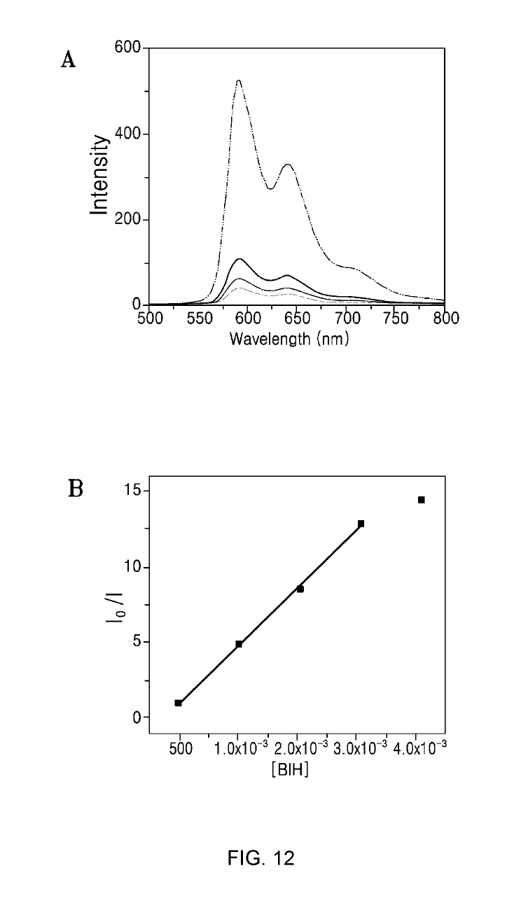

Eqs 1-6 of FIG. 11 show essential reaction processes for discussing structure-reactivity relationships in the present photosensitized CO₂ reduction based on the binary system. The initiation process for the photosensitized CO₂ reduction in either the binary hybrid system or the homogeneous system should be electron transfer from BIH to triplet-state PS (³PS*=³Ir—X⁺* or ³Ru(bpy)₃²⁺*) to generate the one-electron reduced species of PS (PS^{-·}) (eq 1). This is supported by the complete phosphorescence quenching by 0.1 M BIH for each of PS. FIG. 12 shows a Stern-Volmer plot for quenching of the Ir-^{t}Bu⁺ phosphorescence by BIH as a typical example; the quenching rate constant was calculated from the slope of the plot and the phosphorescence lifetime to be 5.85×10⁸ M⁻¹s⁻¹. A further support of eq 1 is given by the considerably negative free-energy changes (ΔG_{A}=−(0.46˜0.48) eV), which are calculated from the excited-state reduction potentials of ³PS* (E_{red}*=0.7˜0.8 V vs SCE for Ir—X⁺ and 0.68 V for Ru(bpy)₃²⁺) and the oxidation potential of BIH (Eₒₓ=0.25 V). Furthermore, irradiation of a DMF solution containing each of Ir—X⁺ and BIH for 5 min gave a new absorption spectrum with the maximum at 510-540 nm, which is essentially identical with the spectrum of [Ir—X⁻]^{-·} obtained by electroabsorption spectroscopy. An alternative initiation process would be the direct electron injection from ³PS* into TiO₂. However, this process is unlikely to occur, because decay profiles of the Ir-^{t}Bu⁺ phosphorescence are unchanged. In accord with this, the excited-state oxidation potential of ³PS* (Eₒₓ*=−-(0.78-1.09 V)) is considerably less negative than the flat-band potential (E_{fb}=−1.50 V) of a TiO₂ nanoparticle film in acetonitrile in the presence of 3% water. For the homogeneous photosensitization, electron transfer from ³Ir—X⁺* to RePE would be another possible process apart from eq 1. However, quenching of the Ir-^{t}Bu⁺ phosphorescence by RePE was very inefficient; a Stern-Volmer plot gave a rate constant of ˜10⁶ M⁻¹s⁻¹, which is smaller by two orders of magnitude than that for quenching by BIH.

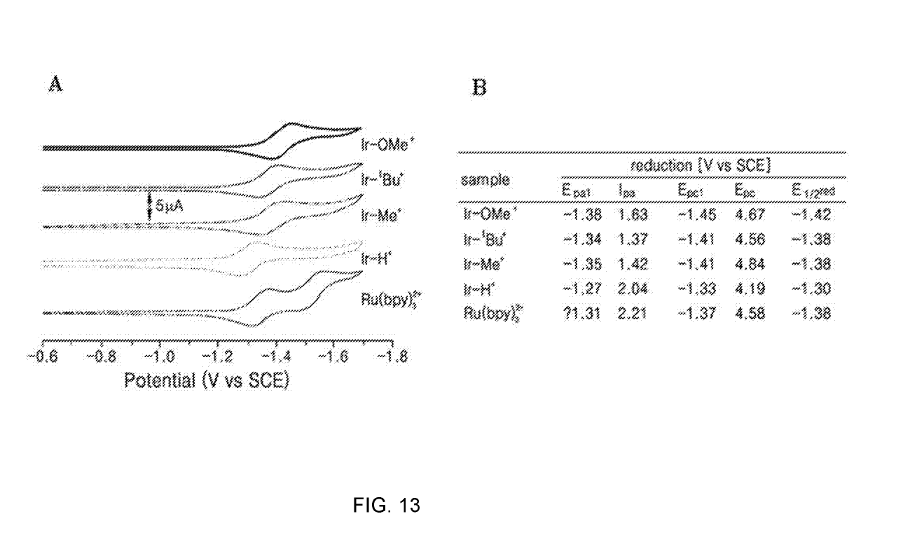

The second important process is collisional electron injection from PS^{-·} into TiO₂ followed by transport of the injected electron (TiO₂(e⁻) to ReC (eq 2). The electron injection should depend on the differences between the conduction-band edge of TiO₂ and the oxidation potential of PS^{-·}. The latter is approximately given by the anodic peak (Eₚₐ^{red}) in the reduction wave of PS listed in FIG. 13.

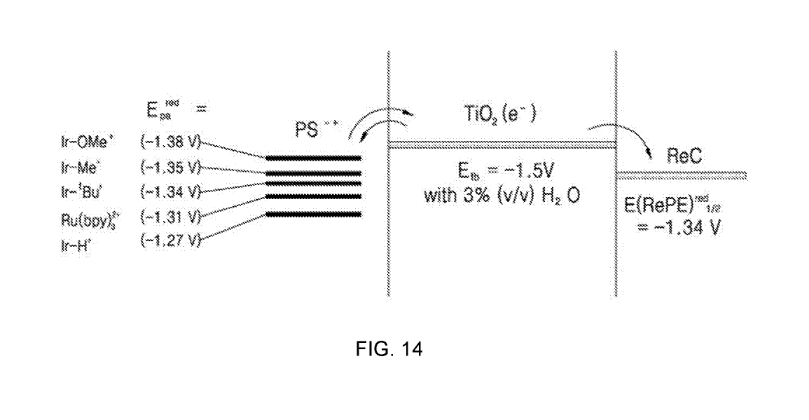

On the other hand, the conduction-band edge of TiO₂ is known to be close to the experimentally determined flat-band potential (E_{fb}), which is ˜−1.50 V vs SCE for a TiO₂ nanoparticle film in the presence of 3% water in DMF. If the E_{fb} value is applicable to the present TiO₂ particles dispersed in DMF, the electron injection from PS^{-·} into TiO₂ should be endergonic by 0.12˜0.23 eV (FIG. 14).

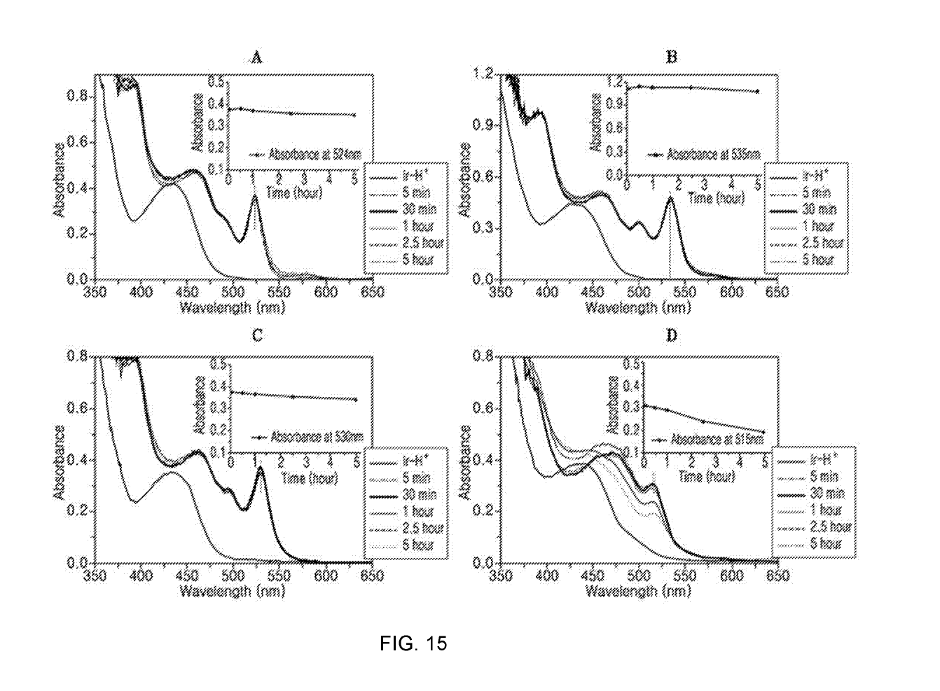

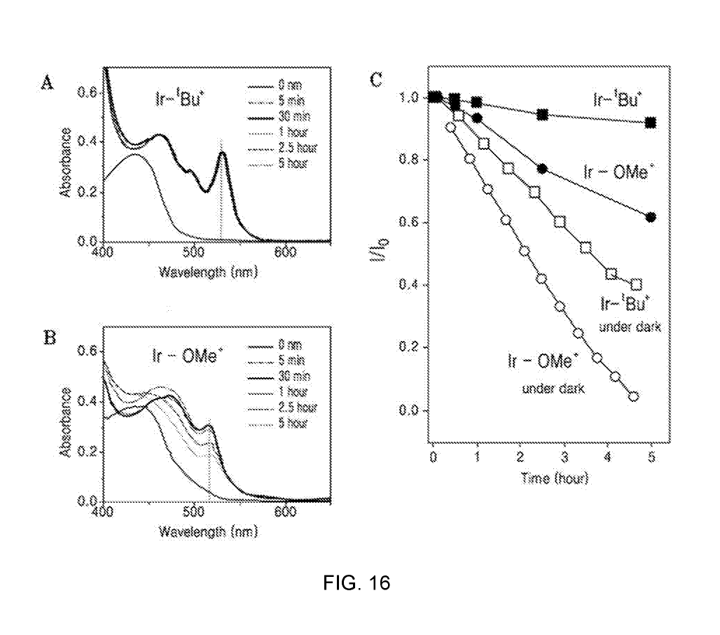

Under such conditions, the electron injection might only slowly proceed in equilibrium with electron reversal from TiO₂(e⁻) to PS. It should be, however, noted that each PS^{-·} generated by irradiation of PS in the presence of BIH can survive for several hours in the absence of TiO₂, long-lived enough to undergo slow electron injection into TiO₂ (FIG. 15).

In an effort to estimate the collisional electron transfer kinetics from the PS^{-·} to the TiO₂, the samples were prepared with adding 1 mg TiO₂ particles into Ar-saturated DMF solution involving 0.1 mM Ir-^{t}Bu⁺ and 10 mM BIH and 2.5 vol % H₂O. The quenching behaviour of [Ir-^{t}Bu⁺]^{-·} absorption peak by TiO₂ is monitored under the dark condition, which is maintained after 5 min. irradiation to generate the reductively quenched [Ir-^{t}Bu⁺]^{-·} species in the presence of BIH. The faster component (˜38 s) might be assigned to electron transfer from PS^{-·} to TiO₂ in diffusion layer, while the slower component (˜44 min.) can be assigned to the long-lived PS^{-·} in the outward diffusion layer of TiO₂ surfaces. With increasing the amount of TiO₂ particles (ranging from 1 to 4 mg), the decay of absorption peak is substantially accelerated (˜10 s, the faster phase), indicating that the collisional electron transfer from PS⁻¹⁹ to TiO₂ is highly sensitive to the surface area of added TiO₂ particles (eq 2). Based on these observations, the inventors reason that the electron transfer rate on diffusion layer is in a few second at real photocatalysis using 10 mg TiO₂ particles.

In reality, TiO₂ nanoparticles have complex chemical and morphological features on their surfaces (14c) and a variety of energetically distributed trap sites, so that electrons injected from an excited-state dye may reveal complex kinetic behavior (S. H. Lee et al., Org. Lett., 12:460-23, 2010). It was reported that very fast trapping of electrons occurs with subpicosecond time constants on bandgap excitation of TiO₂ particles, whereas other investigations indicated the existence of long-lived electrons. This means that the electrons injected into a TiO₂ particle should show complex kinetic behavior, as has been demonstrated by multiple-component decays of transients formed by electron injection from a photoexcited dye into TiO₂ as well as by direct photoexcitation of TiO₂. Therefore, a crucial question emerges about what CR process(es) would be essential in determining the net efficiencies of H₂ generation.

Under such circumstances, it can be presumed that the net efficiency of electron transport to ReC would be sensitively affected by various factors such as the small differences in Eₚₐ^{red}, steric properties of PS and distributions of the odd electron in PS^{-·}. Provided that the photosensitization efficiencies in the early stage of the reaction are related to the amounts of injected electrons, it is of interest to note that Ir-OMe⁺ is significantly more efficient as photosensitizer than Ir-^{t}Bu⁺ and Ir-Me⁺ even though the Eₚₐ^{red} differences are only 40 mV. Presumably, the strong electron-donating effect of the OMe substituents would prevent significant population of the odd electron on the bpy ligand to push the electron toward the btp ligand. In the other PS^{-·}, however, the negative charge would be more or less delocalized over the whole ligands. The particular electronic character of [Ir-OMe⁺]^{-·} might be indicated by the broad spectrum different from the common sharp spectra for other (Ir-X⁺)^{-·}. In photoreaction using Ru(bpy)₃²⁺ as PS, the relatively low selectivity and activity of CO production can be explained by the catalytic production of HCOOH (a competitive by-product) by [Ru(bpy)₂(DMF)₂]²⁺-type complexes, which would be generated via photochemical ligand substitution during photolysis. The formation of dimeric Ru complexes is evidenced by the absorption peaks reshaped with a substantial decrease of original absorption peak of [Ru(bpy)₃²⁺]^{-·} under continuous light irradiation. From these data, it can be concluded that free Ir complexes are more suitable as a photosensitizer in photocatalytic CO₂ reduction system than Ru complex.

The reduction of CO₂ to CO requires net two-electron transfer to ReC from TiO₂(e⁻), which should sequentially proceed. The simultaneous transfer of two electrons as an alternative process is unlikely to occur, because E_{fb} of TiO₂ is considerably less negative than the two-electron reduction potential of ReC. The one-electron reduced species of ReC (ReC^{-·}=L(CO)₃ReCl^{-·}) generated by the initial one-electron transfer from TiO₂(e⁻) to ReC gives the 17-electron species (L(CO)₃Re^{·}) as a key intermediate after the liberation of Cl⁻ (eq 3) followed by coordination of a solvent molecule (eq 4). This species is known to interact with CO₂, probably by the coordination of CO₂ to the metal center (eq 5). Although the follow-up processes are not fully explored, the second electron transfer should occur with electrons deposited in TiO₂ after the coordination of CO₂ to complete the CO₂ reduction under participation of protons (eq 6).

These chemical processes (eq 3 -6) can be considered to be slower than the electron-transfer processes (eq 1 and 2), a situation that leads to a mismatch between the electron flow and the chemical processes. As the consequence, PS^{-·} might be increasingly accumulated in solution with elapsing of irradiation time after TiO₂ has been filled up with electrons. In cases where PS^{-·} undergo chemical changes during the CO₂reduction, the efficiency of photosensitized CO formation would start to drop after PS has been significantly consumed. This might lead to the levelling-off behaviour of photosensitized CO formation observed in a later stage of the reaction. The lower the chemical stability of PS^{-·}, the sooner the levelling-off behaviour would appear. Changes of absorption spectra following irradiation time for Ar-purged DMF solution containing Ir—X⁺ (X=OMe or ^{t}Bu) and BIH in the absence of TiO₂ are shown in FIG. 16. While the absorption peaks at ˜520 nm attributable to [Ir—X⁻]^{-·} were commonly grown up after 5 min irradiation, further irradiation resulted in substantial decreases of the [Ir-OMe⁺]^{-·} absorption in contrast to minor changes in the case of [Ir-^{t}Bu⁺]^{-·}. Net chemical changes of Ir-OMe⁺ significantly occurred during the photosensitized CO₂ reduction whereas Ir-^{t}Bu⁺ was relatively stable. These observations indicate that the different long-term photosensitization capabilities of Ir-^{t}Bu⁺ and Ir-OMe⁺ are mainly attributable to the photochemical changes of [Ir—X⁺]^{-·}. Probably, the very bulky and chemically stable ^{t}Bu substituents would block [Ir-^{t}Bu⁻]^{-·} from possible unwanted chemical changes during the photosensitization cycle. In the case of Ir-OMe⁺, on the other hand, the strong electron-donating effect of the OMe substituent would be divergent; the localization of the odd electron of PS^{-·} on the btp ligand would help the electron injection into TiO₂ but enhance the photochemical reactivity of PS^{-·}.

While details of the present invention have been described above, it will be evident to those skilled in the art that such detailed descriptions are merely preferred embodiments and do not limit the scope of the present invention. Therefore, the true scope of the present invention should be defined by the appended claims and their equivalents.

What is claimed is:

1. A catalytic system comprising an iridium (Ir) photosensitizer and a TiO₂/Re(I) complex catalyst.

2. The catalytic system according to claim 1, wherein the valence of the iridium is trivalent.

3. The catalytic system according to claim 1, wherein the iridium photosensitizer is selected from the group consisting of Ir-OMe⁺, Ir-^{t}Bu⁺, Ir-Me⁺, and Ir-H⁺.

4. The catalytic system according to claim 1, further comprising a sacrificial reagent.

5. The catalytic system according to claim 4, wherein the sacrificial reagent is BIH.

6. The catalytic system according to claim 1, wherein the catalytic system is a binary system.

7. The catalytic system according to claim 1, wherein the catalytic system reduces carbon dioxide (CO₂).

8. The catalytic system according to claim 1, wherein the catalytic system produces carbon monoxide (CO).
